(19) United States
(12) Patent Application Publication
(10) Pub. No.: US 2003/0082365 A1
(43) Pub. Date: May 1, 2003

(54) Tough and durable insulation boards produced in-part with scrap rubber materials and related methods

(76) Inventors: John R. Geary, Carmel, IN (US); Bruce F. Douglas, Zionsville, IN (US); Terence J. O'Connor, Carmel, IN (US); Greg A. Brandt, Zionsville, IN (US); John B. Letts, Carmel, IN (US)

Correspondence Address: Chief Intellectual Property Counsel, Bridgestone/Firestone, Inc., 1200 Firestone Parkway, Akron, OH, 44317-0001, US

(21) Appl. No.: 10/020,826

(22) Filed: Oct. 30, 2001

(51) Int. Cl. B32B 3/26; B32B 3/00; B32B 9/00

(52) U.S. Cl. 428/318.4; 428/304.4; 428/312.2; 428/312.6; 428/312.8; 428/322.7; 428/308.4

(57) ABSTRACT

A composite recovery board (10, 20, 30) comprises a foam core (11) having lower (12) and upper (13) surfaces, wherein the foam core is selected from the group consisting of polyisocyanurate and polyurethane materials and mixtures thereof; and a filler within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof. A method of re-roofing a roof comprising applying composite boards (10, 20, 30) of the present invention to a roof deck and applying a weather protective layer over the composite boards. A continuous method of making composite recovery boards (10) of the present invention comprises is also provided.

### BACKGROUND OF THE INVENTION

This invention relates to a composite board suitable for use as an insulation or recovery board within a roof system. Particularly, the present invention relates to a composite board having improved dimensional stability, especially when exposed to extreme environmental conditions including high heat, humidity and moisture.

Roof construction in a low-pitched roof generally consists of a roof deck, an insulation barrier above the deck, a weather resistant layer applied to the insulation layer, and optionally a layer of heat resistant material. The roof deck generally includes materials such as wood, gypsum, concrete, steel, and the like. Above the roof deck, insulation boards are typically applied to provide thermal insulation and a uniform surface to which the weather protective layer is applied. The most common insulation boards are made of polyisocyanurate, and recovery boards are typically made of woodfiber or extruded polystyrene. Polyisocyanurate may be coated with a protective facer that can be either rigid or flexible and can be fire or flame-retardant. In a re-roofing operation, the roof deck can refer to the existing roof, including the existing insulation and weather resistant layer.

Insulation or recovery boards, as they are referred to in re-roofing, have been employed where the existing roof is leaking. These boards are generally applied to a built-up roof deck to provide a uniform surface when recovering an existing roof. The most common recovery boards are made of woodfiber or extruded polystyrene. Extruded polystyrene typically does not contain a facer.

There are a variety of products that are used as recovery boards including standard polyisocyanurate boards, woodfiber, perlite, Dens-Deck and extruded polystyrene among others. All have limitations, for example, the polyisocyanurate boards is an excellent insulator, but it is not a structural board and can be damaged with excess foot traffic or load and is somewhat moisture sensitive. Woodfiber is relatively durable unless it gets wet and then it degrades quickly into a soggy mess. Perlite is relatively less durable and also turns into a soggy mess in the presence of water and cannot be used with fully adhered single ply roofing systems. Dens-Deck is a good board but is relatively expensive. And extruded polystyrene is sensitive to temperatures that are very close to roof temperatures and is not very durable.

Another key component of any recover board is cost. Ideally, a recover board should be durable to stand up to roof traffic for extended periods of time, be relatively moisture resistant, insensitive to roof top temperatures and be relatively inexpensive. Additionally, any board that is produced has to be manufactured in an inexpensive manner, which usually involves a continuous process. The board will most likely contain a facing material on both of the major sides of the board.

To seal the roof from the elements, the insulation or recovery boards are typically covered with various materials including molten asphalt, modified bitumen membrane, rubberized asphalt, or an elastomeric composition such as EPDM (ethylenepropylene diene monomer). Not all sealing materials mentioned previously are compatible with each type of insulation or recovery board. For example, molten asphalt cannot be used with extruded polystyrene. Correct combinations of sealing material and insulation or recovery boards are known to those skilled in the industry.

Finally, the heat resistant layer of material, which is generally applied directly to the weather resistant layer, can include gravel, river stone, foam or a layer of mastic covered by gravel and the like.

Application of the weather protective layer can be accomplished by a number of means, usually dictated by the type of material employed. For example, sheets of a protective membrane can be rolled out over the roof and bonded together by torching or the use of an adhesive.

The patent literature does include panels and boards used for roofing operations. Built-up roof constructions and the components thereof, for example, are well known in the art.

Thus, a need still exists for an inexpensive recovery board that is tough, durable, moisture resistant and inexpensive.

### SUMMARY OF THE INVENTION

An aspect of the present invention is to provide a relatively inexpensive composite board, particularly for use in re-roofing that is dimensionally stable in hot, humid and wet conditions.

Another aspect of the present invention is to produce a durable, tough and moisture resistant recover board that is relatively inexpensive by utilizing materials such as rubber tire vents that are normally not used and instead are typically discarded.

Generally the present invention provides a composite board comprising a foam core having upper and lower surfaces, wherein said foam core is selected from the group consisting of polyisocyanurate and polyurethane materials and mixtures thereof; and a filler within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof.

In another embodiment, the present invention includes a method of re-roofing a roof comprising applying composite recovery boards to a roof deck, the recovery boards comprising a foam core having upper and lower surfaces, wherein the foam core is selected from the group consisting of polyisocyanurate and polyurethane materials and mixtures thereof; and a filler within the foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof; and applying a weather protective layer over the recovery boards.

In still another embodiment, the invention provides a continuous method of making a composite board comprising the steps of feeding a first sheet of facer material into a conveyor assembly; depositing a filled foamable polymer liquid onto the facer; feeding a second facer material into the conveyor assembly above the filled foamable polymer liquid; allowing the filled foamable polymer liquid to rise between the facer materials in order to form filled polymer foam of a predetermined thickness; curing the polymer foam under heat to create the composite board; and cutting the composite board to desired lengths.

Using a filled foam core within the composite board of the present invention makes it dimensionally stable and relatively insensitive to moisture in re-roofing; the present invention thereby meets the existing need for a recovery board that can be exposed to moisture during installation and remain dimensionally stable while wet and during the eventual evaporation of the moisture.

### BRIEF DESCRIPTION OF THE DRAWINGS

FIG. 1 is a perspective view of one embodiment of a composite board in accordance with the present invention;

FIG. 2 is a perspective view of another embodiment of a composite board in accordance with the present invention;

FIG. 3 is a perspective view of a filled foam core in accordance with the present invention; and

FIG. 4 is a schematic view of an apparatus employed to manufacture the composite boards of the present invention.

### DETAILED DESCRIPTION OF ILLUSTRATIVE EMBODIMENTS

The present invention is directed toward a composite board or roofing member that is used to reroof an existing roof. The composite board or roofing member is applied to a roof deck that is substantially flat or low-pitched, and may be newly constructed, or is exposed by the removal of old roofing or, which is an existing built-up roof in suitable condition for recovering. Inasmuch as roof decks are known and do not constitute part of the present invention, other than as a base upon which the roofing members are laid, further detail is not necessary. Although the roofing members can be utilized as part of new roof installations, the boards are specifically designed for reroof operations.

One common problem in most, if not all reroof installations, is a wet and often somewhat deteriorated roof or substrate. Typically, when a leak is noticed, and certainly when it is deemed necessary to repair, use of the board of the present invention provides an inexpensive and facile means of re-roofing either the affected area or more commonly, the entire roof. Thus, the roofing member must have sufficient integrity to patch or cover the roof; it must provide a good base for subsequent application of the final layer or covering, such as an EPDM roofing membrane; and, it must be compatible with the latter and the respective means of application.

In order to provide a recovery board that is tough, durable, moisture resistant and inexpensive, the present invention utilizes inexpensive filler materials incorporated into the foam material comprising the body of the board. Although a variety of materials can be used, scrap materials are preferred because they are inexpensive. The use of inexpensive materials such as rubber tire vents, EPDM scrap material, plastic chips, polyurethane scrap, polyisocyanurate scrap, scrap rubber from recycled tires, wood chips, fiberglass strands, other generally inexpensive materials and mixtures thereof tends to produce a product that is inexpensive. Additionally, these materials can offer durability and toughness to the product. The polyisocyanurate or polyurethane foam acts as a continuous medium to bind these materials together and to bond the combined composite to the facers.

The filler, or discontinuous medium, will be strong, tough and durable and may comprise at least one of the following fillers, rubber tire vents, EPDM scrap material, scrap plastic chips, polyurethane scrap, polyisocyanurate scrap, scrap rubber from recycled tires, wood chips, fiberglass strands, as well as other generally inexpensive materials and mixtures thereof.

Enhanced flammability resistance can be obtained by adding solid or liquid flame-retardants. In the case of liquid flame-retardants, they will most likely reside in the continuous medium. For aesthetic reasons carbon black or other colors can be added, which in the case of liquid colorants will most likely reside in the continuous medium.

The amount of these components in the discontinuous medium can vary in weight percent relative to the continuous medium from 1 to 0.5 up to 1 to 100 (continuous to discontinuous). All that is necessary is that the continuous medium is adhered well to the facers and the discontinuous medium(s). Amounts of the filler material (discontinuous) are considerably higher than typically used in polyurethane foam applications.

With reference to the drawings, composite boards according to the present invention are best described with reference to FIGS. 1-3. The composite board, indicated generally by the numeral 10, comprises a filled foam core 11 having lower and upper surfaces, 12 and 13, respectively. Mating with lower surface 12 of filled foam core 11 is a facer material 14 and mating with upper face 13 is facer material 15. Within filled foam core 11 is filler material 18.

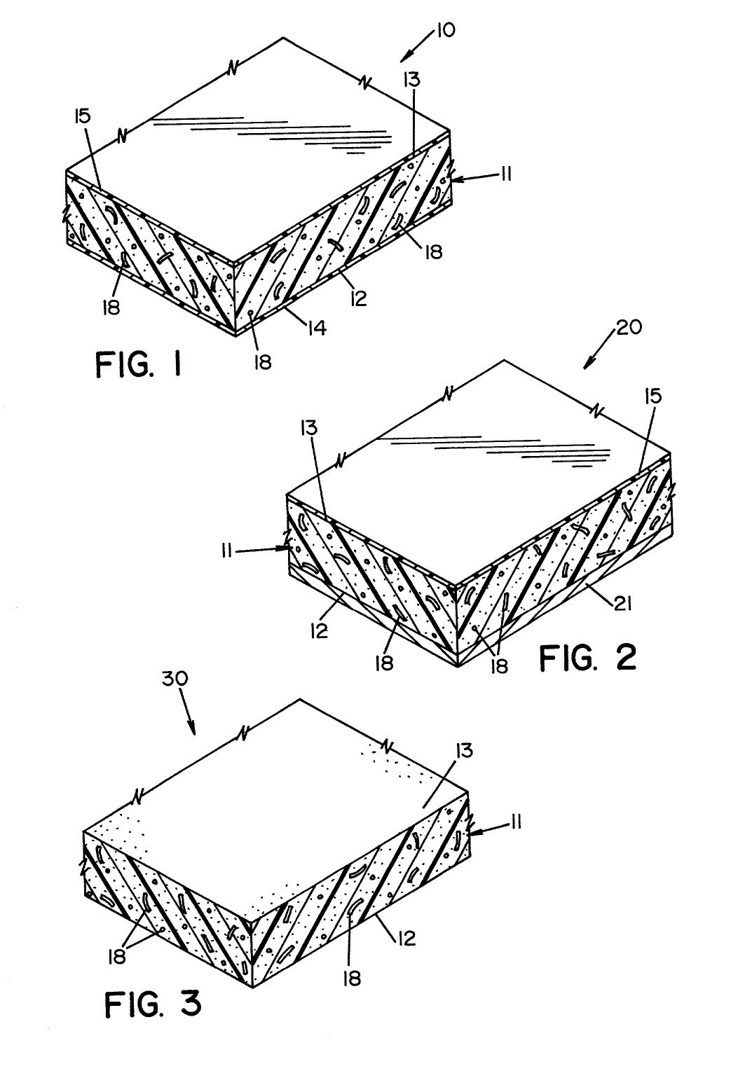

In another embodiment of the present, the composite board according to the present invention is described with reference to FIG. 2. The composite board, indicated generally by the numeral 20, comprises a filled foam core 11 having lower and upper surfaces, 12 and 13, respectively. Mating with lower surface 12 of filled foam core 11 is a substrate material 21, such as gypsum board, and mating with upper face 13 is facer material 15. Within filled foam core 11 is filler material 18. It is also conceivable to manufacture a composite board that comprises a filled foam core 11 having lower and upper surfaces, 12 and 13, respectively, having the substrate material 21, such as gypsum board, mating with lower surface 12 and no facer material mating with upper face 13. Such an embodiment is not depicted separately but would resemble the composite board 20 without the facer material 15.

In another embodiment of the present, the composite board according to the present invention is described with reference to FIG. 3. The composite board, indicated generally by the numeral 30, comprises a filled foam core 11 having lower and upper surfaces, 12 and 13, respectively. Within filled foam core 11 is filler material 18. Unlike the composite boards 10 and 20, the board 30 does not carry any substrate 21 or facer materials 14, 15.

Composite boards 10, 20 and 30 are generally from about 1.2 to about 10.2 centimeters thick, and can be fabricated in various dimensions depending on the intended application. Boards fabricated into sheets 1.2 meters wide and 2.4 meters long are best suited for compatibility in the building trade.

It will be appreciated that the foamed filled cores 11 are identical and thus, reference shall be made generally to the foam core 11 unless otherwise noted. The foam that makes up the filled foam core 11 can be polyisocyanurate, polyurethane, or mixtures thereof. The foam is generally of standard production and generally includes those having an iso index of about 250. Particularly, when polyisocyanurate foam is employed, those having an iso index above 200 are preferred; and when urethane is employed, an iso index above 120 is generally employed. Further, mixed foam can be employed, such as a mixture of polyisocyanurate and polyurethane. Nominal density of the polyisocyanurate and polyurethane foams is about 32 kilograms per cubic meter (kgcm).

The facers may comprise polymer materials, reinforced polymer materials, reinforced cellulosic material, paper, aluminum foil and trilaminates thereof. In particular, the polymer material can include nylon, polyesters, polypropylene, polymer latexes, or mixtures thereof, and the cellulosic material can include recycled paper, cardboard and the like. Examples of polypropylene/polymer latex mixtures include styrene-butadiene rubber (SBR), polyvinyl chloride and polyvinyl alcohol. Thicknesses of the facers typically range between about 0.025 and 0.38 centimeters.

The polymer materials and cellulosic materials for the facers are reinforced with a material selected from the group consisting of glass strands, glass fibers and mixtures thereof. Amounts of such reinforcing materials range from about 100 to about 10,000 parts by weight, based upon 100 parts by weight of the polymer selected to form the facer. More preferably, the reinforcing materials range from about 500 to about 5000 parts by weight, based upon 100 parts by weight of the polymer selected to form the facer. Furthermore, the reinforced polymer material can optionally include fillers such as clay, mica, talc, limestone (calcium carbonate), gypsum (calcium sulfate), aluminum trihydrate, antimony oxide, cellulose fibers, plastic polymer fibers, and mixtures thereof. Amounts of such fillers range from about 0 to about 5000 parts by weight, based upon 100 parts by weight of the polymer selected to form the facer.

In one embodiment, in lieu of a particle board or wood fiber base, the present invention substitutes a layer of gypsum board, which acts as a substrate 21, and which is adhered to the lower surface 12 of the filled foam core 11 (FIG. 2). A suitable substrate/board for this purpose is described in U.S. Pat. No. 5,220,762, the subject matter of which is incorporated herein by reference. Such gypsum boards are manufactured by Georgia-Pacific Corporation and sold under their registered trademark, DENS-DECK. Similar gypsum boards would be equally suitable for practice of the present invention. The advantages include lower cost than wood products and, greater resistance to moisture and wet environments, thereby providing vastly better dimensional stability.

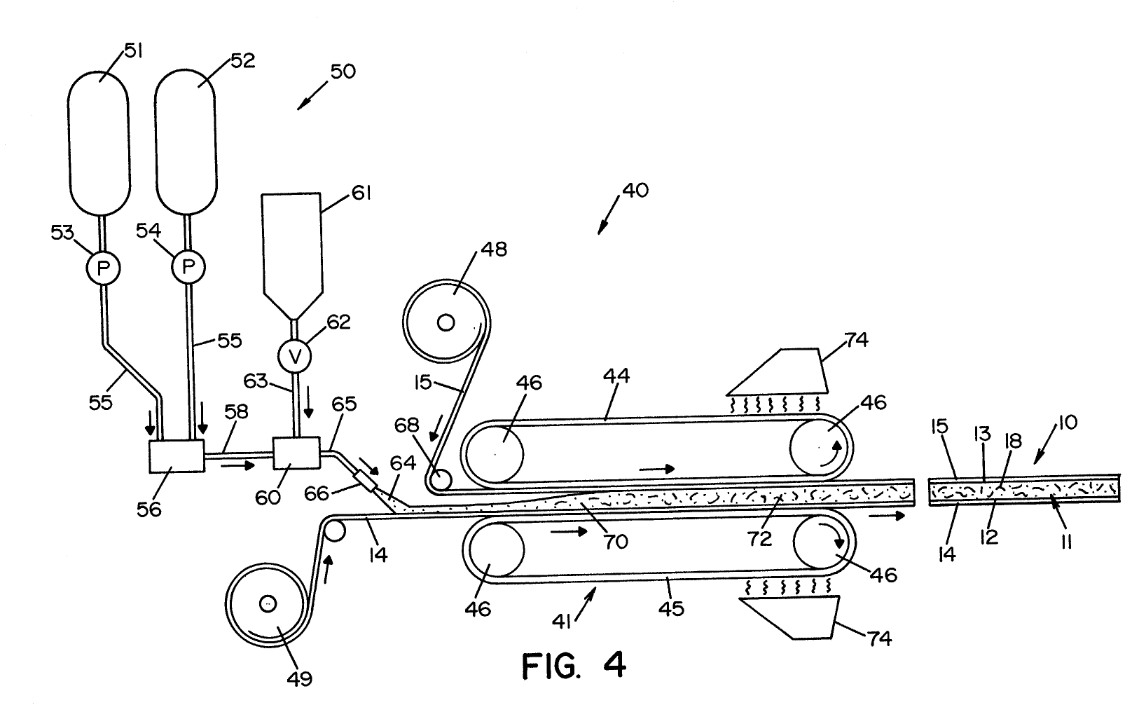

While the composite boards may be manufactured in a batch, continuous, or on-line method, the on-line method is preferred because such a method is both efficient and economical. With reference to FIG. 4, a continuous method for producing embodiments of the present invention is schematically depicted in conjunction with apparatus 40. Apparatus 40 provides conveyor assembly 41 that employs continuous belts or treads, 44 and 45, reeved around a series of rolls 46, several of which are driven. Facer material 15 is carried by an upper spool 48 that is positioned for feeding into conveyor assembly 41. Facer material 14 is carried by a lower spool 49 and is fed into in-feed belt 45.

The process equipment employed to fully disperse the discontinuous medium 11 into the continuous medium 10 prior to laying the material on the bottom facer 14 is included in the polymer feed mechanism of the apparatus, indicated generally by the numeral 50. The polymer feed mechanism includes reservoirs 51 and 52, or whatever number is required by the polymer foam composition selected. Where the desired foam is a polyurethane, for instance, reservoir 51 may provide the isocyanate component and reservoir 52 may provide the polyol component. Resin materials from these reservoirs are fed through metering pumps 53 and 54 and through appropriate conduits 55 into a first chamber 56, where the components are adjusted in reactivity, not to expand before the discontinuous medium has adequately dispersed into it.

From first chamber 56, the polymer foam travels through conduit 58 into solids mixing chamber 60. Filler material is introduced into solids mixing chamber 60 from feeder 61 and passes through a metering valve 62 and conduit 63 into the chamber 60. When both the foam components and the filler material have entered solids mixing chamber 60, they are agitated until a homogenous mixture is obtained. This homogenous filled foamable composition 64 then travels via conduit 65 to dispensing nozzle 66. Enough energy is expanded for the continuous medium to cover approximately 90% of the discontinuous medium with at least a thin layer.

Dispensing nozzle 66 then delivers an appropriately metered amount of filled foamable composition 64, onto the surface of moving facer 14. Subsequently, and slightly downstream of dispensing nozzle 66, facer material 15 is fed into the drive assembly 41, passing around a feed roller 68, which positions facer 15 against upper belt 44. As facers 14 and 15, and deposited filled foamable composition 64 are conveyed, the latter rises, as depicted at 70, until facer 15 is in complete contact with upper belt 44. It is to be appreciated that belts 44 and 45 are adjustable to accommodate the desired thicknesses of board 10.

After the foaming has completed, intermediate product 72, is heated to effect curing of filled foamable composition 64. This is accomplished by appropriately located heaters 74, or by passage through an oven (not shown). After heating for the appropriate time (residence) and temperature, the product emerges from the conveyor and is cut to length to produce composite boards 10. Such cutting is within the skill of the art, including flying cut-off saws and the like, which provide desired dimensions without interruption of apparatus 40. While lengths can be varied at will on such apparatus, the widths of the composite boards 10 can subsequently be trimmed to size in a separate operation, as necessary. It is also possible to provide sidewalls (not shown) in conjunction with drive assembly 41, to define the desired widths as the polymer is foaming within the conveyor.

A laboratory prototype of this invention with rubber tire vents dispersed in the foam gave a strong product (three times the compressive strength of a standard polyisocyanurate board i.e., 70 psi). Addition of rubber tire vents was found to improve toughness and durability. Because roof traffic on commercial roofs especially new construction can lead to facer delamination and crushed foam, the product of this invention will minimize the effect of such roof traffic. Rubber incorporation into the foam enhances water resistance. Finally, although gypsum altered products, such as Dens-Deck, utilized in conjunction with the board 20, will perform very well as a recover board, they do increase the cost. The preferred product of this invention, composite board 10, will be approximately 40% less expensive than the board 20; however, due to the addition of inexpensive filler material 18 into its foam core 21, that product will also benefit from increases in strength and water resistance.

Although the method has been described in conjunction with the manufacture of composite board 10, it is to be appreciated that the board 20 can be similarly fabricated with substitution of a substrate material, such as DENS DECK or particle board, for the lower facer 14. Similarly, it is to be appreciated that the board 30 can be similarly fabricated by the use of temporary facers materials in lieu of facers 14 and 15, which facers can subsequently be removed to provide a facer less board 30.

Use of the board in re-roofing is practiced in the same manner as the installation of known recovery boards and basically involves the steps of applying composite recovery boards to a roof deck, and applying a weather protective layer over the recovery boards.

Thus, it should be evident that the composite boards and methods of the present invention are highly effective in providing composite boards useful for re-roofing. The invention is particularly suited for re-roofing, but is not necessarily limited thereto. The method of the present invention for manufacturing varying embodiments of the present inventions composite boards, can be practiced with other equipment and, the method for re-roofing can be practiced with the variety of boards 10, 20 and 30 that fall within the scope of the present invention.

Based upon the foregoing disclosure, it should not be apparent that the use of composite boards with filled foam cores described herein will provide the benefits set forth herein. It is, therefore, to be understood that any variations evident fall within the scope of the claimed invention and thus, the selection of specific component polymers, fillers, facer materials and the like can be determined without departing from the spirit of the invention herein disclosed and described. In particular, composite boards according to the present invention are not necessarily limited to those having a filled polyisocyanurate or polyurethane foam core. Moreover, as noted hereinabove, the independent composition(s) of the polymer facer(s) can be varied, particularly with the use of optional fillers. Thus, the scope of the invention shall include all modifications and variations that may fall within the scope of the attached claims.

What is claimed is:

1. A composite board comprising:
a foam core having upper and lower surfaces, wherein said foam core is selected from the group consisting of polyisocyanurate and polyurethane and mixtures thereof; and
a filler material within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof.

2. A composite board, as set forth in claim 1, wherein said foam core comprises polyisocyanurate having an iso index above 200.

3. A composite board as set forth in claim 1, further comprising a facer material applied to one of said surfaces of said filled foam core.

4. A composite board as set forth in claim 3, wherein said facer material is selected from the group consisting of polymer materials, reinforced polymer materials, reinforced cellulosic material, paper, aluminum foil and trilaminates thereof.

5. A composite board, as set forth in claim 4, wherein a facer material is applied to said other surface of said filled foam core.

6. A composite board, as set forth in claim 5, wherein a substrate material is applied to said lower surface of said filled foam core in lieu of said facer material.

7. A composite board, as set forth in claim 1, wherein a substrate material is applied to one of said surfaces of said filled foam core.

8. A method of re-roofing a roof comprising:
applying composite recovery boards to a roof deck, said recovery boards comprising
a foam core having upper and lower surfaces, wherein said foam core is selected from the group consisting of polyisocyanurate and polyurethane and mixtures thereof; and
filler material within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof; and
applying a weather protective layer over said recovery boards.

9. A method of re-roofing a roof, as set forth in claim 8, further comprising the step of applying a facer material to one of said surfaces of said filled foam core.

10. A method of re-roofing a roof, as set forth in claim 9, wherein said facer material is selected from the group consisting of polymer materials, reinforced polymer materials, reinforced cellulosic material, paper, aluminum foil and trilaminates thereof.

11. A method of re-roofing a roof, as set forth in claim 10, including the step of applying a second facer material to said other surface of said filled foam core.

12. A method of re-roofing a roof, as set forth in claim 8, including the step of applying a substrate material to said lower surface of said filled foam core in lieu of said facer material.

13. A method of re-roofing a roof, as set forth in claim 8, wherein a substrate material is applied to one of said surfaces of said filled foam core.

14. A continuous method of making a composite board comprising the steps of:
feeding a first sheet of facer material into a conveyor assembly;
depositing a filled foamable polymer liquid onto said facer;
feeding a second facer material into the conveyor assembly above the filled foamable polymer liquid;
allowing said filled foamable polymer liquid to rise between said facer materials in order to form filled polymer foam of a predetermined thickness;
curing said polymer foam under heat to create the composite board; and
cutting the composite board to desired lengths.

15. A continuous method, as set forth in claim 14, wherein said recovery boards comprise
a foam core having upper and lower surfaces, wherein said foam core is selected from the group consisting of polyisocyanurate and polyurethane and mixtures thereof; and
filler material within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof.

16. A continuous, as set forth in claim 14, wherein said recovery board further comprising a facer material applied to one of said surfaces of said filled foam core.

17. A continuous, as set forth in claim 16, wherein said facer material is selected from the group consisting of polymer materials, reinforced polymer materials, reinforced cellulosic material, paper, aluminum foil and trilaminates thereof.

18. A continuous, as set forth in claim 14, wherein said recovery board further comprises a second facer material is applied to said other surface of said filled foam core.

19. A continuous, as set forth in claim 18, wherein a substrate material is applied to said lower surface of said filled foam core in lieu of said facer material.

20. A composite board, as set forth in claim 14, wherein a substrate material is applied to one of said surfaces of said filled foam core.
